(19) United States
(12) Patent Application Publication
(10) Pub. No.: US 2025/0287296 A1
(43) Pub. Date: Sep. 11, 2025

(54) DIFFERENTIATED REGISTERING TO NETWORK SLICES IN A WIRELESS COMMUNICATIONS NETWORK

(71) Applicant: LENOVO (SINGAPORE) PTE. LTD, Singapore (SG)

(72) Inventors: Genadi Vasilev Velev, Darmstadt (DE); Apostolis Salkintzis, Glika Nera (GR); Dimitrios Karampatsis, Ruislip (GB)

(73) Assignee: Lenovo (Singapore) Pte. Limited, Singapore (SG)

(21) Appl. No.: 18/862,751

(22) PCT Filed: Jun. 23, 2022
(86) PCT No.: PCT/EP2022/067113

§ 371 Date: Nov. 4, 2024

(30) Foreign Application Priority Data
May 5, 2022 (GR) 20220100382

(51) Int. Cl. H04W 48/18; H04W 8/22

(52) U.S. Cl. CPC H04W 48/18; H04W 8/22

(57) ABSTRACT

There is provided a wireless communication device comprising a processor and a transceiver. The processor is arranged to determine a reason for a registration to a first network slice. The transceiver is arranged to transmit an indication of the reason. wherein the indication is transmitted associated with the first network slice. The transceiver is further arranged to receive identities of a set of allowed network slices.

### FIELD

The subject matter disclosed herein relates generally to the field of implementing differentiated registering to network slices in a wireless communications network. This document defines a wireless communication device, a method in a wireless communication device, a wireless communication network, and a method in a wireless communication network.

### BACKGROUND

A (Radio) Access Network, (R)AN, may comprise 3GPP RANs like UTRAN, E-UTRAN, NR and non-3GPP RATs like WLAN, or may also comprise a 5G access network (5G-AN).

In 5th generation (5G) wireless communication networks, network slicing is a feature which allows the network operator the ability to divide (or “slice”) the network in finer small complete networks in order to provide customized features towards 3rd party customers (service providers that provide services to user devices). A network slice spans through the access network (RAN, NG-RAN or non-3GPP access) and core network (CN, 5GC). In this sense a network slice is a logical network that comprises a set of network functions and corresponding resources (e.g. computing, storage, networking) necessary to provide certain network capabilities and network characteristics.

3GPP Technical Specification 23.501, v17.4.0, March 2022, is titled “System Architecture for the 5G System”; the 5G System provides data connectivity and services, this specification covers both roaming and non-roaming scenarios in all aspects, including interworking between 5GS and EPS, mobility within 5GS, QoS, policy control and charging, authentication and in general 5G System wide features e.g. SMS, Location Services, Emergency Services.

3GPP Technical Specification 23.502, v17.4.0, March 2022, is titled “Procedures for the 5G System”, and defines the Stage 2 procedures and Network Function Services for the 5G system architecture described in 3GPP TS 23.501, v17.4.0 and for the policy and charging control framework which is described in 3GPP TS 23.503, v17.4.0.

3GPP Technical Specification 23.503, v17.4.0, March 2022, is titled “Policy and charging control framework”, and defines the Stage 2 policy and charging control framework for the 5G System specified in TS 23.501 v17.4.0 and TS 23.502 v17.4.0

### SUMMARY

A problem with known wireless communication networks is that they are unable to control and ensure the proper utilization of network slices.

Disclosed herein are procedures for implementing differentiated registering to network slices in a wireless communications network. Said procedures may be implemented by a wireless communication device or a wireless communication network.

Accordingly, there is provided a wireless communication device comprising a processor and a transceiver. The processor is arranged to determine a reason for a registration to a first network slice. The transceiver is arranged to transmit an indication of the reason, wherein the indication is transmitted associated with the first network slice. The transceiver is further arranged to receive identities of a set of allowed network slices.

There is further provided a method in a wireless communication device, the method comprising: determining a reason for a registration to a first network slice; transmitting an indication of the reason, wherein the indication is transmitted associated with the first network slice; and receiving identities of a set of allowed network slices.

There is further provided a wireless communication network comprising a transceiver arranged to receive from a wireless communication device an indication of a reason for a registration to a first network slice, wherein the indication is received associated with the first network slice. In response to the indication, the transceiver further arranged to send identities of a set of allowed network slices to the wireless communication device.

There is further provided a method in a wireless communication network, the method comprising: receiving from a wireless communication device an indication of a reason for a registration to a first network slice, wherein the indication is received associated with the first network slice; and in response to the indication, sending identities of a set of allowed network slices to the wireless communication device.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for implementing differentiated registering to network slices in a wireless communications network will now be described, by way of example only, with reference to the accompanying drawings, in which:

FIG. 1 shows example 5GS architecture 100 for a UE 110 associated with two network slices;

FIG. 2 depicts a user equipment apparatus 200 that may be used for implementing the methods described herein;

FIG. 3 depicts further details of the network node 300 that may be used for implementing the methods described herein;

FIG. 4 illustrates a method in a wireless communication device;

FIG. 5 illustrates a method in a wireless communication network; and

FIG. 6 illustrates further details of an example implementation of a solution presented herein.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of Band C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

In 5th generation (5G) wireless communication networks, network slicing is a feature which allows the network operator the ability to divide (or “slice”) the network in finer small complete networks in order to provide customized features towards 3rd party customers (service providers that provide services to user devices). A network slice spans through the access network (RAN, NG-RAN or non-3GPP access) and core network (CN, 5GC). In this sense a network slice is a logical network that comprises a set of network functions and corresponding resources (e.g. computing, storage, networking) necessary to provide certain network capabilities and network characteristics.

A network operator may like to control the use of a network slice, i.e. to limit the number of UEs registering with the network slice or the number of PDU Sessions established in the network slice. This is known as network slice admission control (NSAC). Further, the network operator may wish to optimize the performance of their network depending on the current slice load. In general, there can be other reasons why a network operator may wish that UEs register with a network slice when the UE has a traffic to transmit over the network slice.

The UE can be configured with network slice relevant information, which is referred as Network Slice Selection Assistance information (NSSAI). The NSSAI may consist of single or multiple S-NSSAIs (single Network Slice Selection Assistance information). The UE requests registration to network slices by sending to the 5GC a NAS registration request message including a Requested NSSAI containing a list of one or more S-NSSAIs to which the UE wants to register. The UE may send the NAS registration request message to an AMF in the 5GC. The 5GC may send to the UE in the registration accept message or in UE configuration update command message one or more of the following elements related to the network slice configuration of the UE: allowed NSSAI, configured NSSAI, rejected NSSAI or pending NSSAI. The NSSAI is a list of one or more S-NSSAIs. Any of these elements may be sent to the UE by the AMF, but the content of the allowed NSSAI, configured NSSAI, rejected NSSAI may be created either in the AMF or in the Network Slice Selection Function (NSSF) which interrogates with the AMF.

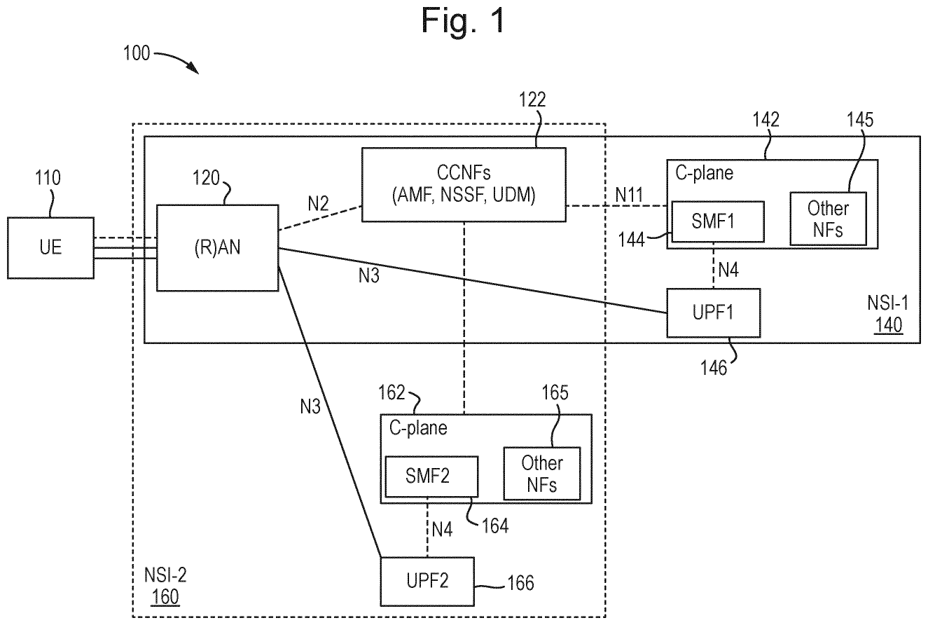

FIG. 1 shows example 5GS architecture 100 for a UE 110 associated with two network slices, wherein the network slices are deployed correspondingly over network slice instance 1 (“NSI-1”, 140) and network slice instance 2 (“NSI-2”, 160) depicted in dotted line. UE 110 may comprise a user equipment apparatus 200 or a UE 610 as described herein. According to this example architecture the (radio) access network “(R)AN” 120 is part of the two slices 140, 160 and it is shared. The Core Network part of the network slices (or NSIs) has a Common Control Plane Network Functions (CCNFs) 122 and dedicated CN Network Functions like SMF1 144, UPF1 146, and other NFs 145 belonging to NSI-1 140 and SMF2 164, UPF2 166 and other NFs 165 belonging to NSI-2 160. CCNF 122 may comprise a network node 300 or an AMF/NSSF 630 as described herein.

Please note that FIG. 1 does not include all NFs and all reference points. More information about the functionality of the NFs (e.g. AMF, NSSF, SMF, UPF, etc.), the reference points and the 5GS can be found in references 3GPP TS 23.501, v17.4.0 and 3GPP TS 23.502, v17.4.0.

When an application being executed by the UE requests connectivity for data transmission, the UE determines which network slice (and which PDU Session) to use based on the URSP rules or on UE Local Configuration as described in 3GPP TS 23.503 v17.4.0, where further details about the URSP policies can be found. 3GPP TS 23.503 v17.4.0 specifies that the Route Selection Descriptor (RSD) of a URSP rule is considered valid if the S-NSSAI present in the RSD is in the Allowed NSSAI (e.g. for the non-roaming case and in the mapping information of the Allowed NSSAI to HPLMN S-NSSAI(s) for the roaming case). Having such behavior would mean that the UE should include in the Requested NSSAI all S-NSSAIs from the Configured NSSAI.

The UE has an implementation freedom and based on which applications the UE wants to used, the UE constructs the requested NSSAI as described in 3GPP TS 23.501, v17.4.0 clause 5.15.5.2.1.

Furthermore, 3GPP TR 23.700-41 v0.2.0 describes that: “a UE Registers/Deregisters with a Network Slice and establishes/tears down PDU sessions based on own policy taking into account network provided information such as the URSPs. However, this does not allow an operator e.g. to enforce that the UE only registers with a S-NSSAI when it is actually needed to have connectivity in the related network slice. A UE may in fact choose to register with all the Configured NSSAIs and then use the URSP just to decide which DNNs to connect to at run time.”

An issue with the known network slice registration procedure is that the network is not able to determine whether to allow or not allow a registration to a network slice dependent upon whether the network slice will be used by the UE or not. Making such a determination would tend to allow the network to control the UE behavior. There is a problem in known wireless communication networks that the network

is unable to control and ensure the proper utilization of network slices in the system.

In known networks, a network function such as the AMF may configure a time value in the UE associated with an S-NSSAI which indicates that the S-NSSAI is to be deregistered upon inactivity of the data transmission. When data connectivity is not any longer used, the AMF and the UE start a timer with the configured time value. Upon expiry of the timer, both the UE and the network implicitly remove the S-NSSAI form the Allowed NSSAI.

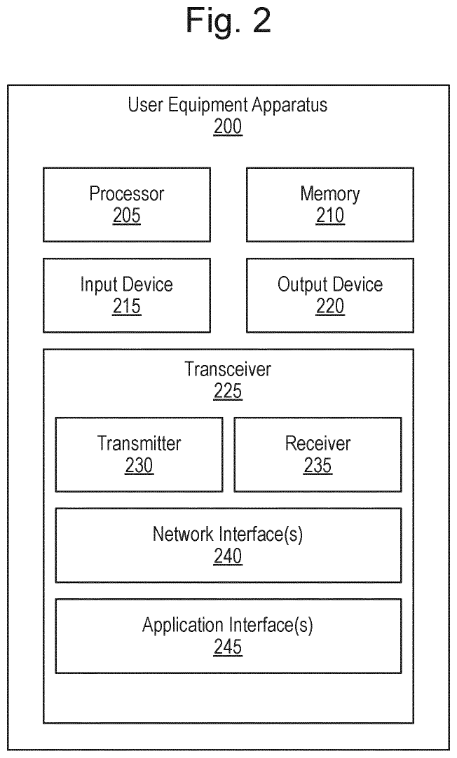

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, user equipment apparatus 200 may comprise a UE 110 or a UE 610 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

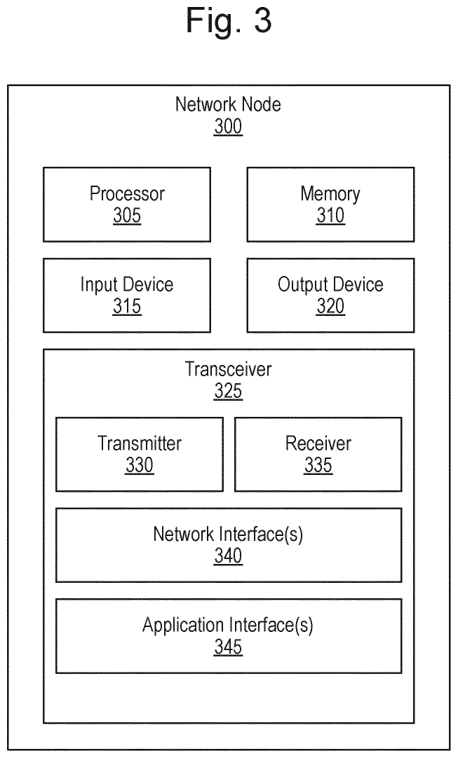

FIG. 3 depicts further details of the network node 300 that may be used for implementing the methods described herein. The network node 300 may be one implementation of an entity in the wireless communications network, e.g. in one or more of the wireless communications networks described herein. In particular, the network node 300 may comprise a CCNF 122 or an AMF/NSSF 630 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound.

For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

Accordingly, there is provided a wireless communication device comprising a processor and a transceiver. The processor is arranged to determine a reason for a registration to a first network slice. The transceiver is arranged to transmit an indication of the reason, wherein the indication is transmitted associated with the first network slice. The transceiver is further arranged to receive identities of a set of allowed network slices.

The wireless communication device thus has the ability to register with different types of network slice dependent upon the reason for network slice registration. The wireless communication network is thus able to better control use of the resources within the wireless communication network. The resources may comprise network slices. Controlling use of resources within the wireless communication network may comprise restricting UE registration to a particular network slice to UEs which need to use the network slice or to UEs for which the network slice is default one. A particular UE may need to use a particular network slice to implement a user equipment route selection policy rule.

The wireless communication device may be suitable for communicating with a wireless communication network. The reason for registration may be one of: proactive, for immediate use or for a default application. The transceiver may be further arranged to transmit a registration request to register the wireless communication device with the first network slice in the wireless communication network.

The processor may be further arranged to determine the whether the first network slice is identified in the set of allowed network slices or rejected network slices, and if it is not, and if the first network slice is identified in a route selection descriptor of a route selection policy rule, then the transceiver may be arranged to send a registration request for the first network slice.

The transceiver may be further arranged to receive from a wireless communication network, a configuration requiring that the wireless communication device include an indication of the reason for any registration to a network slice. The configuration may be received from an Access and Mobility management Function or from the Unified Data Management function of the wireless communication network.

The transceiver may be further arranged to transmit the indication of the reason for registration to the first network slice as part of a registration request message.

The indication of the reason for a registration to a first network slice may comprise at least one of: registration due to usage of the first network slice indicating that an application traffic is ready to be sent over the first network slice; or proactive registration indicating that an application may use the first network slice any time later; or registration to the first network slice indicating that a default application is to use the first network slice.

The wireless communication device may be a user equipment.

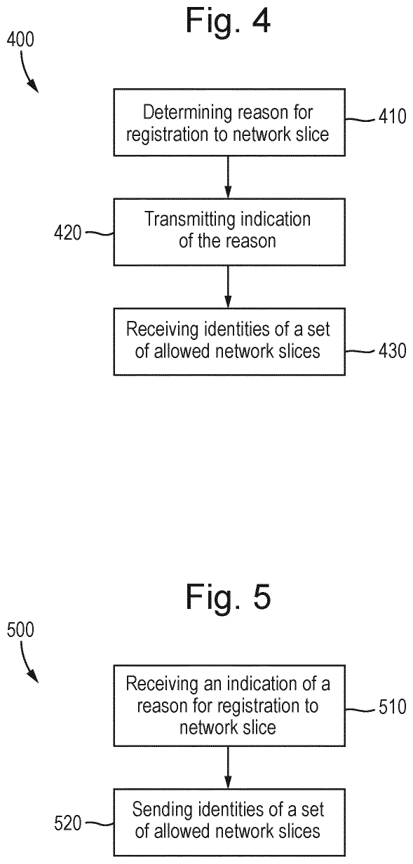

FIG. 4 illustrates a method 400 in a wireless communication device, the method 400 comprising: determining 410 a reason for a registration to a first network slice; transmitting 420 an indication of the reason, wherein the indication is transmitted associated with the first network slice; and receiving 430 identities of a set of allowed network slices.

There is further provided a wireless communication network comprising a transceiver arranged to receive from a wireless communication device an indication of a reason for a registration to a first network slice, wherein the indication is received associated with the first network slice. In response to the indication, the transceiver further arranged to send identities of a set of allowed network slices to the wireless communication device.

The wireless communication network is thus able to create a set of allowed network slices by considering the indicated reason for a network slice registration. The wireless communication network is thus able to better control use of the resources within the network. The resources may comprise network slices. Controlling use of resources within the wireless communication network may comprise restricting UE registration to a particular network slice to UEs which need to use the network slice. A particular UE may need to use a particular network slice to implement a user equipment route selection policy rule.

The wireless communication network may comprise an Access and Mobility management Function. The wireless communication device may be a user equipment. The wireless communication device may be suitable for communicating with a wireless communication network. The reason for registration may be one of: proactive, for immediate use or for a default application. The transceiver may be further arranged to receive a registration request to register the wireless communication device with the first network slice in the wireless communication network.

The transceiver may be further arranged to send to the wireless communication device, a configuration requiring that the wireless communication device include an indication of the reason for any registration to a network slice. The configuration may be sent to the UE from an Access and Mobility management Function of the wireless communication network.

The transceiver may be further arranged to receive the indication of the reason for any registration to a network slice as part of a registration request message. The transceiver is further arranged to receive, from the wireless communication device, a registration requested for the first network slice.

The wireless communication network may comprise an Access and Mobility management Function. The wireless communication network may comprise a Network Slice Selection Function and wherein an Access and Mobility management Function forwards, to the Network Slice Selection Function, the received reason for registration to a network slice.

The wireless communication network may further comprise a processor, the processor arranged to determine whether to allow the wireless communication device to register with the first network slice based on the received reason for registration to the first network slice. The determination whether to allow the wireless communication device to register with the first network slice may further be based on a configuration in the AMF. The configuration in the AMF may mean the AMF may either (1) have received a configuration from the OAM system or (2) has received a configuration indication from the UDM or (3) based on current load situation of the network slice. The AMF may thus know (i.e. is configured) how to process the received UE's reason for slice registration.

The transceiver may be further arranged to receive an indication associated with the first network slice as to whether a registration to the first network slice is to be allowed when a request for registration to the first network slice is received with a specific reason for a registration. The specific reason for registration may be that the network slice is for immediate use, that is, data is ready to be sent via the network slice. The indication associated with the first network slice as to whether a registration to the first network slice is to be allowed may be received from the UDM. The indication associated with the first network slice as to whether a registration to the first network slice is to be allowed may be based on the reason for registration provided from the UE. The indication associated with the network slice may be part of the UE subscription data.

FIG. 5 illustrates a method 500 in a wireless communication network, the method 500 comprising: receiving 510 from a wireless communication device an indication of a reason for a registration to a first network slice, wherein the indication is received associated with the first network slice; and in response to the indication, sending 520 identities of a set of allowed network slices to the wireless communication device.

A problem with the known network slice registration procedure is that the network does not know the reason for the network slice registration request from the UE. For example, a known network cannot know whether the UE requests a registration to network slice due to (a) immediate need to use the network slice, or (b) proactive registration in order to use the slice at some later time point. Therefore, the network is not able to determine whether to allow or not allow a registration to a specific requested network slice. According to the arrangements described herein, the Access and

Mobility Management Function (AMF) or Network Slice Selection Function (NSSF) determine whether to allow or not allow a registration to a specific requested network slice. It is assumed that the AMF or NSSF can serve the requested network slices in the current area.

Please note that the terms “network slice”, “slice” and “S-NSSAI” are used with

the similar meaning in this disclosure and can be used interchangeably. The S-NSSAI is the identifier of the network slice in a network. Whenever the “S-NSSAI” is used, it is meant to be the S-NSSAI value of the home network (e.g. HPLMN, or HPLMN S-NSSAI). It is also possible that the UE uses (i.e. sends or receives) S-NSSAI values of the VPLMN which are mapped to the HPLMN S-NSSAI values; and in such case the UE may use both values (i.e. the UE sends or receives both the HPLMN S-NSSAI values and the corresponding mapped VPLMN S-NSSAI values). In other words, whenever it is stated herein that the S-NSSAI is sent/received it can be also understood that home network S-NSSAI and corresponding serving network S-NSSAI values are sent/received.

According to a first arrangement presented herein, the UE provides type of requested S-NSSAI.

The main principle of this first arrangement is that the UE sends, to the network, information to indicate different reasons for the request for registration to an S-NSSAI.

In other words, the UE indicates to the network (e.g. an AMF in the network) a type of S-NSSAI registration request. The type of S-NSSAI registration request may comprise a reason for the S-NSSAI registration request. For example, the UE may indicate that a registration to an S-NSSAI is (a) due to a need to use the S-NSSAI or (b) a proactive registration.

Accordingly, the UE determines to include an S-NSSAI in the Requested NSSAI due to a need to use the S-NSSAI or due to proactive registration with the network slice. Such reasons may include:
Slice registration for (immediate) usage or need: an application may request connectivity and a matching URSP rule includes the S-NSSAI in the RSD. For example, an application (e.g. YouTube) may request connectivity to an application server (e.g. a YouTube server). The UE determines that it needs to register to the S-NSSAI of the matching URSP rule's RSD, as the application matches the traffic descriptor of the URSP rule. In this sense, the UE needs the slice registration for (immediate) usage.
Proactive slice registration: based on UE implementation, the UE may want to register to an S-NSSAI in order to be able to immediately establish a PDU Session in this network slice when needed at some point of time.
Slice registration for default applications (or due to “always on”/default S-NSSAIs): the UE is aware that the network slice is used for default applications (e.g. IMS voice application for voice-centric UE) and the UE always includes the S-NSSAI in the Requested NSSAI. In one example, upon power up of UE or during deactivation of airplane mode, the operating system may determine that some default application, such as IMS, OS update manager, wants connectivity to transmit data.

The UE includes in the registration request message a parameter associated with a requested S-NSSAI. The parameter may comprise a reason for the registration request. The parameter may indicate that the S-NSSAI registration is proactive (i.e. the UE does not intend to use the S-NSSAI immediately). In other words, the UE may request a first group of one or more S-NSSAI(s) which will be used immediately and a second group of one or more S-NSSAI(s) which are not intended to be used immediately.

Once the UE is registered with the network and stores an allowed NSSAI, the UE may determine: if an application requests a connectivity and there is a matching

URSP rule with RSD containing an S-NSSAI not part of the allowed NSSAI or rejected S-NSSAIs, the UE may first trigger a registration procedure (of type mobility update) and include the S-NSSAI in the requested NSSAI. After the S-NSSAI becomes part of the allowed NSSAI, the UE starts the establishment of a PDU Session as per application's request.

The implication in the UE when processing the URSP rules is that an RSD of a matching URSP rule may be subsequently evaluated to be valid (or invalid) after the registration procedure is completed and if the S-NSSAI is included in the allowed NSSAI the RSD is determined to be valid, otherwise if the S-NSSAI is not included in the allowed NSSAI the RSD is determined to be invalid.

Where reference is made herein to slice registration or network slice registration or S-NSSAI registration, these terms include the S-NSSAI in the requested NSSAI in a NAS registration request message.

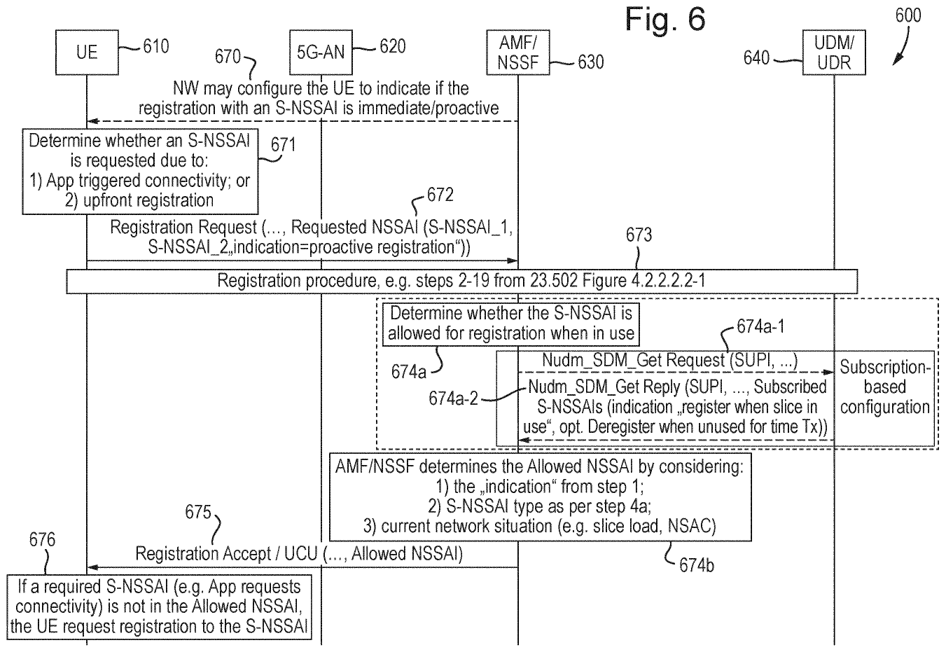

FIG. 6 illustrates further details of an example implementation of a solution presented herein. A system 600 comprises a UE 610, a 5G access network 620, an AMF/NSSF 630, and a UDM/UDR 640 (Unified Data Management/Unified Data Repository). UE 610 may comprise a UE 110 or a user equipment apparatus 200 as described herein. AMF/NSSF 630 may comprise a CCNF 122 or a network node 300 as described herein.

At 670, the network (e.g. AMF 630 based on local policies) may configure the UE 610 to send additional information for the slice registration type, i.e. the UE 610 is configured to indicate the type or reason for S-NSSAI registration (when sending registration request for the S-NSSAI). The network (e.g. AMF 630) determines whether to configure the UE 610 depending on the characteristics of the deployed network slices. For example, if network slice admission control (NSAC) is configured for an S-NSSAI or a network slice is overloaded, the AMF 630 may determine to request/activate in the UE 610 the reporting of slice registration type or reason. The request/activate from the network to the UE 610 to report the network slice registration type may also be described as activation of a mode of operation in the UE 610, e.g. the network activates/deactivates the mode of operation called “reporting of reason for S-NSSAI registration request”.

The type or reason for slice registration may be either (a) when the S-NSSAI is needed for immediate use, or (b) when the S-NSSAI is not needed immediately but the S-NSSAI can be used at any time later (i.e. proactive slice registration), or (c) when the S-NSSAI is needed (for example immediately or proactively) for default applications which very likely will send traffic.

The AMF 630 may configure the UE 610 to send the additional information for the slice registration type (or reason for slice registration) by using at least one of the following procedures. During the registration procedure by sending a registration accept message containing an indication to request/activate the reporting of the slice registration type. During the UE 610 configuration update (UCU) procedure by sending a UCU command message to the UE 610 containing an indication to request/activate the reporting of the slice registration type. Once the AMF has configured the UE, the AMF may store the successful configuration in the UE's mobility context in the AMF.

In addition, or alternatively, the UE 610 may indicate (e.g. during the registration procedure) that the UE 610 supports the feature of reporting the network slice registration type. For example, the UE 610 may include such support/capability indication in the 5G mobility management (5GMM) capabilities sent in the registration request message. In one example, the capability may indicate “support of indicating slice registration type” or indication with similar meaning.

Please note that in an alternative, the UE may be preconfigured (e.g. locally configured) to always send the type/reason of S-NSSAI registration request to the AMF 630, whenever a new requested NSSAI is sent to the network. The UE may indicate this local configuration to the network in the registration request message. In such case, the network may avoid sending a configuration indication to the UE which requires the UE to send the type/reason of S-NSSAI registration request.

At 671, when the UE 610 performs registration procedure and the UE 610 constructs the requested NSSAI, the UE 610 determines for each S-NSSAI of the requested NSSAI the type/reason of registration. The type/reason for S-NSSAI registration can be due to (a) need for (immediate) usage, (b) proactively in order to be able to directly start establishment of a PDU Session in this S-NSSAI when needed at some later point of time, or (c) needed for default applications (e.g. IMS voice application for voice-centric UE). Further details for the different types of S-NSSAI registrations are described further below.

At 672, the UE 610 sends to the AMF 630 a NAS registration request (RR) message which includes a requested NSSAI. The RR message may include an information to indicate the type/reason for S-NSSAI registration.

In one example, the UE 610 may include a new parameter indicating a list of S-NSSAIs for which proactive registration applies. In another example, the UE may include a new parameter indicating a list of S-NSSAIs for which the slice registration is for immediate use. In yet another example, the requested NSSAI, which contains a list of one or more S-NSSAIs, may contain a flag/marking for the S-NSSAIs which are requested for a specific type of network slice registration, e.g. only the S-NSSAIs for proactive registration are marked.

At 673, the network continues with the registration procedure. Such a registration procedure may be carried out in accordance with steps 2-19 from 23.502 v17.4.0 FIG. 4.2.2.2.2-1, incorporated herein by reference.

At 674a, the network 630 (e.g. AMF or NSSAF, or both) may determine that some of the network slices, which the UE has requested, are subject to specific policy, e.g. (a) the UEs should be registered with a slice when actual usage is needed or (b) should be always requested. The “actual usage” means that there are application(s) in the UE which send/receive data via a PDU Session over this network slice, i.e. send/receive data at least within a given time period (e.g. the PDU Session inactivity is smaller than a specific time value Tx). In other words, if UEs does not “actually use” a network slice (e.g. for time Tx), the UE should be deregistered from the network slice. The other policy for S-NSSAI is allowed to be “always requested” means that the S-NSSAI is a kind of default S-NSSAI to which there are default services (e.g. IMS service for voice-centric UE, or Internet connectivity service for a commercial smartphone). Please note that in the known art, the AMF may receive a list of one or more default S-NSSAIs, however these S-NSSAIs are used in the AMF to be included in the allowed NSSAI if the UE does not send requested NSSAI in the RR message. The proposed solution enhances this concept and the list of default S-NSSAIs may be also used to allow such S-NSSAIs to be included in the allowed NSSAI when the actual mode of operation in the AMF or NSSF is to allow only S-NSSAIs for immediate usage.

There are several options how the AMF/NSSF 630 can determine such S-NSSAIs. In one option, the AMF/NSSF 630 may be locally configured (e.g. from the

OAM system) with a list of S-NSSAIs for which the policy apply that the UEs should be registered with a slice when actual usage is needed. In another option, the UE 610 subscription data from the UDM 640 may include an indication for any of the subscribed S-NSSAIs that UEs should register with this S-NSSAI when the S-NSSAI is actually used. In this case, when the AMF retrieves the UE subscription data from the UDM (e.g. using Nudm_SDM_Get service operation, as shown in the step 674a-1 in FIG. 6), the UDM 640 sends the UE subscription data (shown in the step 674a-2 in FIG. 6) which includes a list of S-NSSAIs that should be allowed to the UEs if the network slice is actually used. For example, such S-NSSAIs may have scarce resources.

In addition, the AMF/NSSF 630 may determine a time period Tx for which an S-NSSAI is considered as “actually used”. The time period Tx can be either locally configured in the AMF 630, or it can be included in the UE 610 subscription data stored in the UDM 640 (i.e. the AMF 630 receives the time period Tx from the UDM 640). If the time period Tx expires, the AMF 630 should consider to deregister the UE from the S-NSSAI, i.e. to remove the S-NSSAI from the list of allowed NSSAI for the UE 610. The network slice deregistration can be in one of the following ways. Network slice deregistration may be performed via explicit signaling between the AMF 630 and UE 610 (e.g. the AMF triggers UE Configuration Update (UCU) procedure to send a new allowed NSSAI excluding the S-NSSAI). Network slice deregistration may be performed via implicit deregistration where there are synchronized timers running in the UE 610 and AMF 630 and upon expiry of the timers the AMF 630 and UE 610 remove the S-NSSAI from the allowed NSSAI without explicit signaling.

At 674b, the AMF/NSSF 630 determines which S-NSSAI are included in the Allowed NSSAI. The AMF/NSSF 630 may take into account at least one of the following information when determining the allowed NSSAI:
the indication received from the UE 610 about the type/reason for S-NSSAI request;
as per step 674a, whether the S-NSSAI is subject to policy to be allowed for registration when the UEs 610 actual use the S-NSSAI; or
the current situation in the network, e.g. the current network slice load. That is, if an S-NSSAI is subject to NSAC (e.g. for number of UE or number of PDU Sessions), the AMF may consider whether the current number of registered UEs (or number of established PDU Sessions) is close to the maximum number of UEs (or maximum number of PDU Session). If yes, the AMF may determine to allow registration to the S-NSSAI only if the reason for registration is for immediate use.

At 675, the AMF 630 sends a registration accept message to the UE 610 including the Allowed NSSAI as determined in step 674b.

The AMF 630 may also use the UE Configuration Update (UCU) update procedure to send UCU Command message to the UE 610 to indicate the new Allowed NSSAI.

At 676, the UE 610 processes the registration accept message as known, for example at 21 from 23.502 v17.4.0, FIG. 4.2.2.2.2-1, incorporated herein by reference.

At some later point, if an App request data connectivity and the corresponding S-NSSAI (e.g. from the a matching URSP rule's RSD with higher priority or from the UE Local Configuration) is not in the allowed NSSAI, the UE 610 first sends a request to register with the S-NSSAI before processing further RSDs or before concluding that the RSD is invalid.

A benefit that tends to be provided according to the solution in FIG. 6 is that the network is provided with a reason for the network slice registration request. Such a reason may comprise for “actual usage”, or it may comprise the network slice being registered proactively (or upfront). The UE provides this information to the network during the registration procedure. By having this information, the network can improve the usage of the network slice resources by assigning the network slice(s) to UEs which currently need data connectivity.

According to a further embodiment, the UE predicts the need for connectivity.

According to this further embodiment, the UE is able to “predict” whether an application will need a connectivity (or is about to be used). The UE predicts the needed connectivity a short time in advance before the real/actual connectivity is triggered (or needed) by the application. This can be for example a capability of the operating system (OS) running on the UE, or a capability of an application.

Where this prediction is a capability of the OS: the OS may monitor and gather statistics of the activity of different applications. For example machine learning (ML) or artificial intelligence (AI) technologies can be used to predict the need of connectivity for an application. When the OS predicts/determines the need of connectivity for an application, the OS can use the connection manager to trigger the establishment of connectivity, i.e. the connection manager can trigger the connectivity establishment and the URSP rules or the UE Local Configuration is used to determine the S-NSSAI corresponding to the application.

Where this prediction is a capability of an application: in this case of application capability, a smart application can request the connectivity before the actual the connectivity is needed.

If the UE/OS or application implements such capability, based on the prediction, the UE request registration to the corresponding S-NSSAI, so that the S-NSSAI can be already part of the Allowed NSSAI when the application triggers the data connectivity.

Predicting a need for connectivity as described here tends to provide the benefit of, upon request for actual connectivity by an application, the corresponding S-NSSAI would be already in the Allowed NSSAI and the UE can start a PDU Session establishment. If the UE is capable of implementing such a solution, the UE may always request registration with network slices by indicating immediate use (i.e., the UE does not need to request proactive registration to S-NSSAIs).

In a further enhancement in this embodiment, in addition to the early registration request to the S-NSSAI, the UE may also start the PDU Session establishment using the RSD components of the matching URSP rule. In this way, when the application actually triggers the data connectivity (e.g. to the connectivity manager of the operating system), the PDU Session may be already established and the data transmission can immediately start.

There is further provided an arrangement wherein the network provides configuration information to the UE. The UE is provided with configuration information indicating different types of configured S-NSSAI (i.e. different types with regard to how the UE requests the registration to the S-NSSAIs). The different types of configured S-NSSAIs provided to the UE may be: (A) one or more additional configured NSSAI parameter (e.g. called “configured NSSAI for default registration” or “configured NSSAI for registration when used”) or (B) as a new flag for the S-NSSAI(s) in the existing configured NSSAI parameter.

The different types of configured S-NSSAIs are described as follows:
A. A first type (or first list) of S-NSSAIs includes the S-NSSAIs to which the UE should request a registration when data connectivity is needed (e.g. for data transmission). The data connectivity can be considered as “actual usage” of the network slice for time period Tx (e.g. as described in step 674a in FIG. 6).
B. A second type (or second list) of S-NSSAIs includes the S-NSSAIs to which the UE may request a registration proactively or at any time, i.e. without a real need for data connectivity over the S-NSSAIs.
C. A third type (or third list) of S-NSSAIs includes the S-NSSAIs to which the UE should always request registration. For example, such S-NSSAIs may include one or more default S-NSSAI(s) corresponding to default service which are activated upon powering on the UE. In one example of a commercial smartphone, the S-NSSAI associated with the default Internet connection (e.g. used for OS updates or internet browsing) may be determined to be a default S-NSSAI, which should be always included in the Requested NSSAI (i.e. always requested for registration).

The network (e.g. the AMF or NSSF 630 as illustrated in FIG. 6) can construct the above mentioned lists of configured S-NSSAIs by using local configuration in the network functions or using the UE subscription data indication as described in steps 674a-1 and 674a-2 in FIG. 6. In other words, the AMF/NSSF determines or is aware of the type of S-NSSAI(s), i.e. such of types ‘A’ (to be requested when the UE usage is required), ‘B’ (without any specific requirement, i.e. can be requested at any time) or ‘C’ (to be always requested).

The UE uses the received configuration information to determine how to construct the requested NSSAI, i.e. which S-NSSAIs to include in the requested NSSAI. For example, the S-NSSAIs from the first list should be included in the requested NSSAI only when the S-NSSAI is to be used, i.e. at least one application in the UE requires data connectivity for this network slice. The S-NSSAIs from the second list configured S-NSSAIs can be included in the requested NSSAI at any time, i.e. the UE can register proactively for such S-NSSAIs or when the S-NSSAI is to be used. The S-NSSAIs from the third list should be always included in the requested NSSAI.

Please note that the UE can be provided with the existing configured NSSAI information, which includes all S-NSSAIs which the UE can use (e.g. in the corresponding serving network), and in addition, the UE may be provided with an additional list of S-NSSAIs which e.g. are to be requested when the network slice is to be used for data connectivity (i.e. first list of S-NSSAIs). In such case, the UE can internally determine the other list (e.g. the second list) of S-NSSAIs.

Alternatively, or in addition, the network can provide the UE with (general) configuration information indicating whether the UE should request registration to network slice(s) only when the network slice is to be used for data connectivity. This (general) configuration information is not associated with a specific S-NSSAI, but it applies to all S-NSSAIs from the configured NSSAI or default configured NSSAI; and can be called ‘operational mode to request S-NSSAI registration’. This (general) configuration information may be applied together with the different types of configured S-NSSAIs as described above, e.g. if the UE is configured to ‘request registration to network slice(s) only when the network slice is to be used’, the UE would include in the requested NSSAI only S-NSSAI which are needed for immediate use (i.e. the UE would not include in the requested NSSAI S-NSSAI for proactive slice registration). In one example, the ‘operational mode to request S-NSSAI registration’ may have the values of:
“1”=the UE request a registration with an S-NSSAI only if an application triggers data connectivity and the matching URSP rule or UE Local Configuration includes the associated S-NSSAI.
“0”=the UE may request a registration with any S-NSSAI from the configured NSSAI or default configured NSSAI.

In addition, the network may send a configuration information for (default) S-NSSAIs to which the UE may always request registration (e.g. S-NSSAIs of type ‘C’). During initial registration procedure, the UE may include such ‘default’ S-NSSAIs in the requested NSSAI.

Such (general) configuration information (or ‘operational mode to request S-NSSAI registration’) can be provided to the UE from network in at least one of the following ways:
By the AMF by including the configuration information in the NAS registration accept message or in the NAS UE Configuration update command message.
By the UDM by including the configuration information in the signaling for UE parameter update procedure, e.g. similar to providing the default configured NSSAI to the UE, but including a new configuration parameter e.g. ‘operational mode to request S-NSSAI registration’.

When the UE receives the (general) configuration information indicating that ‘request S-NSSAI when usage is required’ (or alternatively the ‘operational mode to request S-NSSAI registration’ is set to “1” or activated), the UE includes the S-NSSAI in the Requested NSSAI if an application triggers data connectivity to this S-NSSAI (i.e. the matching URSP rule or UE Local Configuration includes the S-NSSAI in the NSSP) or possibly S-NSSAIs corresponding to default applications and the S-NSSAI is part of the configured NSSAI and not part of the rejected S-NSSAIs.

If the (general) configuration information is not received or the configuration information indicates ‘request S-NSSAI at any time allowed’ (or alternatively the ‘operational mode to request S-NSSAI registration’ is set to “0” or deactivated), the UE includes the S-NSSAI in the Requested NSSAI at any time as long as the S-NSSAI is part of the configured NSSAI and not part of the rejected S-NSSAIs (and of course not part of the allowed NSSAI).

Accordingly, a wireless communication device, which may be a use equipment, has the ability to determine different types of S-NSSAIs to be requested, i.e. whether for immediate/actual use or for proactive registration or corresponding to default application(s). The wireless communication device may send an indication associated with the network slices (i.e. S-NSSAIs) that the registration is proactive or for immediate/actual use. Further, the wireless communication device may receive configuration information from the network (e.g. AMF) indicating whether to indicate the type of S-NSSAI registration (i.e. S-NSSAI registration for immediate/actual use or proactively).

Furthermore, a wireless communication network, in particular the Access and Mobility management Function thereof, may be able to receive a new parameter indicating the type of S-NSSAI registration. The wireless communication network may create allowed NSSAI by considering the indicated type of S-NSSAI registration. Further, the wireless communication network may perform UE configuration to activate/deactivate the reporting of the type of S-NSSAI registration.

There is provided a method for registration of a user equipment (e.g. UE) with a network slice in a communication network, the method comprising the following steps: determining whether a registration to one or more network slices is proactive or for immediate/actual use; transmitting an indication associated with the network slices (i.e. S-NSSAIs) that the registration is proactive or for immediate/actual use; receiving a set of allowed S-NSSAIs(s) (e.g. allowed NSSAI).

The method may further comprise, after receiving a set of allowed S-NSSAIs(s), and if the S-NSSAI is not part of the allowed NSSAI, the UE may determine to request the S-NSSAI if an application requests connectivity and the matching URSP rule includes the S-NSSAI in the RSD.

The method may further comprise, prior to determining a reason for the registration to one or more network slices configuring the UE by the network (e.g. AMF) to include the indication about the type of S-NSSAI registration (i.e. proactive or for immediate use).

The indication associated with the network slices may be transmitted as part of the requested NSSAI (e.g. a list of requested S-NSSAI(s) which are for proactive registration).

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field of the present application.
3GPP 3rd Generation Partnership Project
5GS/5GC 5th Generation System/5th Generation Core network
AMF Access and Mobility Management Function
AS Access Stratum
BS Base Station
EAP Extensible Authentication Protocol
EPC/EPS Evolved packet core/Evolved packet system
FB Frequency Band
ID Identity or identifier
IE Information Element
LTE Long Term Evolution
MM Mobility Management
NAS Non-Access Stratum
NF Network function
NID Network identifier
NPN Non-Public Network
PNI-NPN Public Network Integrated Non-Public Network
NR New Radio
NSSAA Network Slice Specific Authentication and Authorization/
NSSAAF NSSAA Function
NSSAI Network Slice Selection Assistance Information
S-NSSAI Single Network Slice Selection Assistance Information
NSSF Network Slice Selection Function
OAM Operations, Administration and Management
PDU Protocol Data Unit
PLMN Public Land Mobile Network
HPLMN Home Public Land Mobile Network
VPLMN Visited Public Land Mobile Network
(R)AN (Radio) Access Network
RAT Radio Access Technology/Type
RLF Radio Link Failure
RSD Route Selection Descriptor
SM Session Management
SMF Session Management Function
SNPN Standalone Non-Public Network
SOR Steering of Roaming
SP Service Provider
SUPI Subscription Concealed Identifier
TA/TAI Tracking Area/Tracking Area Identity
UDM Unified Data Management
UDR Unified Data Repository
UE User Equipment
CE Route Selection Policy
URSP UE Route Selection Policy

What is claimed is:

1-18. (canceled)

19. A network function (NF) for wireless communication, comprising:
at least one memory; and
at least one processor coupled with the at least one memory and operable to cause the NF to:
generate a policy that specifies one or more conditions under which a user equipment (UE) is to be registered with a network slice; and
transmit an indication of the policy.

20. The NF of claim 19, wherein the NF comprises one or more of an access and mobility management function (AMF) or a network slice selection function (NSSF).

21. The NF of claim 19, wherein the policy is generated based at least in part on a request from the UE for registration with a network which comprises network slice selection assistance information (NSSAI).

22. The NF of claim 19, wherein the policy comprises a condition that the UE registers with a network slice when an application of the UE is to send or receive data over the network slice.

23. The NF of claim 19, wherein the policy comprises an indication that an application of the UE is to send or receive data over a protocol data unit (PDU) via the network slice.

24. The NF of claim 19, wherein the policy comprises an indication that the UE is to send or receive data over the network slice within a specified time period.

25. The NF of claim 19, wherein the policy comprises an indication that if the UE does not send or receive data over the network slice within a specified time period, the UE is to be deregistered from the network slice.

26. The NF of claim 25, wherein to deregister the UE from the network slice, the at least one processor is operable to cause the NF to remove the network slice from allowed network slice selection assistance information (NSSAI) stored in the NF.

27. The NF of claim 19, wherein the network slice is associated with one or more default services for which network slice registration is to be requested.

28. The NF of claim 19, wherein the NF is configured with a set of network slices for which the policy applies.

29. The NF of claim 19, wherein the policy is based at least in part on a UE subscription to the network slice.

30. The NF of claim 29, wherein the at least one processor is operable to cause the NF to:
transmit a request for UE subscription data; and
receive the UE subscription data, wherein the UE subscription data comprises an indication of a set of network slices for which the policy applies.

31. The NF of claim 19, wherein the at least one processor is operable to cause the NF to:
transmit, to the UE, configuration information comprising different types of network slices and information for registration to the different types of network slices.

32. The NF of claim 31, wherein a first type of the different types of network slices comprises a type of network slice for which the UE is to request registration when the UE is to send or receive data.

33. The NF of claim 31, wherein the configuration information is generated based on one or more of local configuration information or UE subscription data.

34. A method performed by a network function (NF), the method comprising:
generating a policy that specifies one or more conditions under which a user equipment (UE) is to be registered with a network slice; and
transmitting an indication of the policy.

35. A user equipment (UE) for wireless communication, comprising:
at least one memory; and
at least one processor coupled with the at least one memory and operable to cause the UE to:
receive an indication of a policy that specifies one or more conditions under which the UE is to be registered with a network slice; and
perform one or more of slice registration or slice deregistration based at least in part on the policy.

36. The UE of claim 35, wherein the policy comprises an indication that if the UE does not send or receive data over the network slice within a specified time period, the UE is to be deregistered from the network slice.

37. The UE of claim 36, wherein the policy comprises an indication that to deregister the UE from the network slice, the network slice is to be removed from allowed network slice selection assistance information (NSSAI).

38. A method performed by a user equipment (UE), the method comprising:
receiving an indication of a policy that specifies one or more conditions under which the UE is to be registered with a network slice; and
performing one or more of slice registration or slice deregistration based at least in part on the policy.
